(19) United States
(12) Patent Application Publication
(10) Pub. No.: US 2018/0338600 A1
(43) Pub. Date: Nov. 29, 2018

(54) Double-Sided Make-Up Applicator

(71) Applicant: Premium Web, LLC, Scottsdale, AZ (US)

(72) Inventor: Adam Dizes, Scottsdale, AZ (US)

(73) Assignee: Premium Web, LLC, Scottsdale, AZ (US)

(21) Appl. No.: 15/987,527

(22) Filed: May 23, 2018

Related U.S. Application Data
(60) Provisional application No. 62/510,674, filed on May 24, 2017.

(51) Int. Cl. A45D 34/04; B32B 27/28; B32B 5/18; B32B 27/06; B32B 27/20; B32B 7/12

(52) U.S. Cl. CPC A45D 34/04; B32B 27/283; B32B 5/18; B32B 27/065; B32B 2266/06; B32B 7/12; A45D 2200/1018; B32B 2266/0214; B32B 2555/00; B32B 27/20

(57) ABSTRACT

A makeup applicator has a non-foam polymer pad and a sponge attached to the non-foam polymer pad. A dye or particulate can be disposed in the non-foam polymer pad. An adhesive can be disposed between the non-foam polymer pad and sponge. A text or picture can be printed on a surface of the sponge that the non-foam polymer pad is attached to. The sponge can include an open-cell polymeric foam.

### CLAIM TO DOMESTIC PRIORITY

The present application claims the benefit of U.S. Provisional Application No. 62/510,674, filed May 24, 2017, which application is incorporated herein by reference.

### FIELD OF THE INVENTION

The present invention relates in general to cosmetics, and more particularly, to a double-sided make-up applicator.

### BACKGROUND OF THE INVENTION

Facial makeup is a critical aspect of many people's daily routines. Applying makeup can be a lengthy process that involves many steps using multiple tools to apply several types of makeup. A person may require one type of applicator for a first makeup step and a second type of applicator for a second type of makeup. In some cases, one type of makeup may require two different applicators, one for applying the makeup onto the face and a different one to blend the makeup into a natural looking coat.

Applying makeup dirties the applicators being used, so as more different applicators are used the amount of work to clean them all is increased. Moreover, being able to apply makeup on the go is complicated by the fact that so many different applicators have to be lugged around. A need exists for a versatile makeup applicator that can simplify the makeup application process.

### BRIEF DESCRIPTION OF THE DRAWINGS

FIGS. 1a-1c illustrate a double-sided makeup applicator combining a sponge applicator and silicone applicator;

FIGS. 2a-2d illustrate use of the double-sided makeup applicator to apply makeup;

FIGS. 3a-3f illustrate alternative shapes for the double-sided applicator;

FIGS. 4a-4c illustrate forming the silicone portion of the double-sided makeup applicator;

FIGS. 5a and 5b illustrate forming the silicone portion with embedded glitter;

FIGS. 6a-6c illustrate forming the sponge portion of the double-sided makeup applicator;

FIGS. 7a-7c illustrate combining the sponge and silicone portions into a double-sided makeup applicator;

FIGS. 8a and 8b illustrate a printed logo between the silicone and sponge portions visible through the silicone portion; and

FIGS. 9a and 9b illustrate an alternative method of forming a double-sided makeup applicator by coating one applicator with a substance having a different property.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

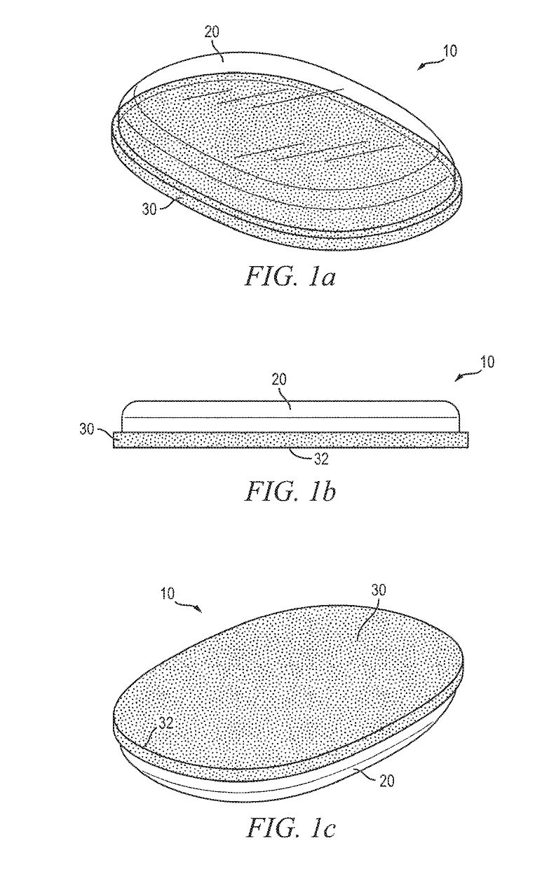

FIGS. 1a-1c illustrate one embodiment of a double-sided makeup applicator 10 having a silicone applicator 20 combined with a sponge applicator 30. FIG. 1a is a view of applicator 10 from silicone side 20, FIG. 1b is a side view, and FIG. 1c is a view of the applicator from sponge side 30. Makeup applicator 10 provides two different types of surfaces for a person to use in applying makeup. Applicator 10 can be flipped between the two sides to use either a silicone or spongy surface depending, on what is desired for a given situation.

Silicone side 20 provides a smooth and non-absorbent surface. The silicone material allows makeup to be applied efficiently because silicone side 20 does not waste makeup by absorbing it. Practically all of the makeup applied to silicone side 20 can be transferred to a user's body, unlike sponge blenders that absorb a significant portion of the makeup. Silicone side 20 can also be used to spread out makeup across skin in a wiping motion, again without significant waste from absorption. While silicone side 20 is useful as a makeup blender, many find the smooth non-absorbent surface lacking for use as a makeup blender.

After applying makeup using silicone side 20, applicator 10 can be flipped for blending with sponge side 30. Sponge side 30 provides a porous surface that will absorb some liquid makeup. However, for purposes of blending, the texture and absorption of sponge side 30 can create a desirable look. A user pats, blots, or rubs the makeup with sponge side 30 to blend the makeup that was previously applied with silicone side 20.

Sponge side 30 can be a polymer, natural sponge, or another suitable foamed material. In one embodiment, sponge side 30 is non-latex. Sponge side 30 includes an edge 32 around the bottom of the sponge that is angled. The angle of edge 32 can be a right angle, obtuse angle, or acute angle. Edge 32 is rounded in other embodiments for an edgeless applicator. Sponge side 30 extends slightly outside of the footprint of silicone side 20. In other embodiments, sponge side 30 and silicone side 20 have substantially the same footprint at the plane where the two sides meet.

Applicator 10 provides two different makeup application surfaces in a single easy to carry and keep track of device. Silicone side 20 provides a smooth non-porous surface while sponge side 30 provides a porous textured surface. Both applicator types are important tools in a makeup user's arsenal. Applicator 10 gives a user both surfaces in a single device. With applicator 10, a user has both a sponge and a silicone applicator while still only having a single makeup applicator to keep track of—a single applicator to clean.

Applicator 10 can be formed by combining any two or more materials to make a more convenient tool for use with applying makeup. A closed-cell polymer foam could be used for silicone side 20 to apply makeup without significant absorption, while an open-cell polymer foam is used for sponge side 30. In other embodiments, two different spongy materials are used. Two different open-cell polymer foams can be used with different cell sizes to provide different textures when applying makeup.

Applicator 10 can be any combination of make-up applicators. Possibilities include open cell sponge, closed cell sponge, sponges of varied densities, natural sponge, velour, microfiber, a flocked texture, a natural hair or bristle applicator, synthetic rubbers or plastics, latex or non-latex foam, medical grade or non-medical grade silicone, gel-based, or anti-bacterial materials. Any two materials can be combined, e.g., an applicator could be formed as a combination of light density sponge and heavy density sponge, or a heavy density sponge can be combined with a silicone applicator. Any materials can be formed and combined using any suitable method and include any of the described features. In addition, more than two materials could be combined into one applicator.

In some embodiments, color is used as a designation of what compound a portion of the applicator is comprised of. For instance, grey could indicate a light density sponge while black indicates a heavier density sponge. The different colors or shades can help identify which side is what material, and also helps indicate where the transition between materials occurs for materials that look and feel similar. Different colors could be reserved for different applicator materials across an entire line of applicators, such that different applicators with materials in common would have those sections in a common color. Any of the applicator materials can be dyed any desirable color.

Besides simply being for application of makeup, an applicator could have one portion configured for applying makeup and another portion configured to be particularly useful in removing makeup. An open cell sponge with small cells might be used to apply and blend makeup, while the reverse side could have significantly larger cells more useful to absorb soapy water and trap makeup during cleaning. The materials of an applicator 10 can be for non-makeup related use as well. One section could be made of volcanic rock or another abrasive material for removing calloused skin. In any case, combining a plurality of tools into one device simplifies a user's routines and reduces the number of separate devices required.

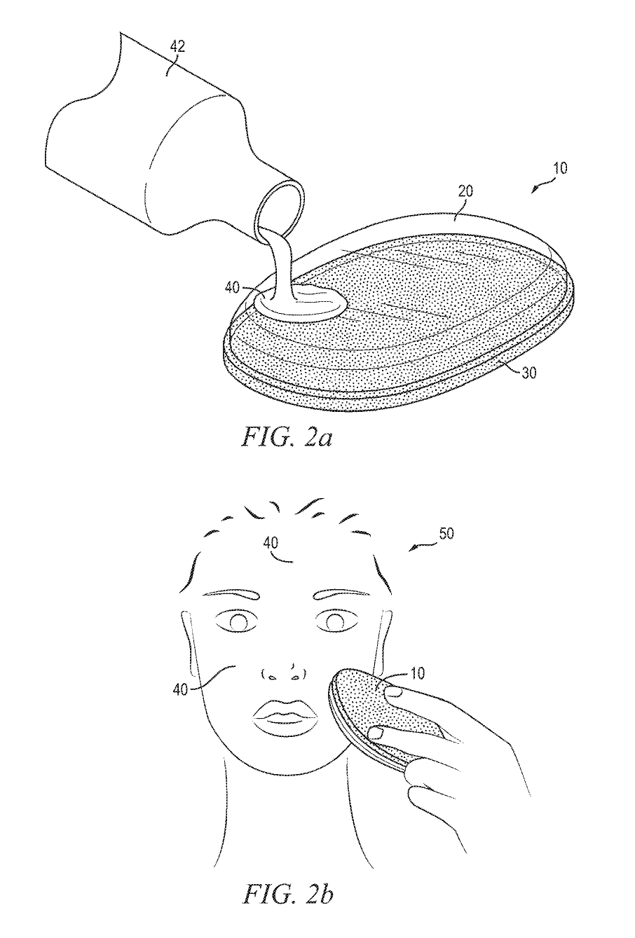

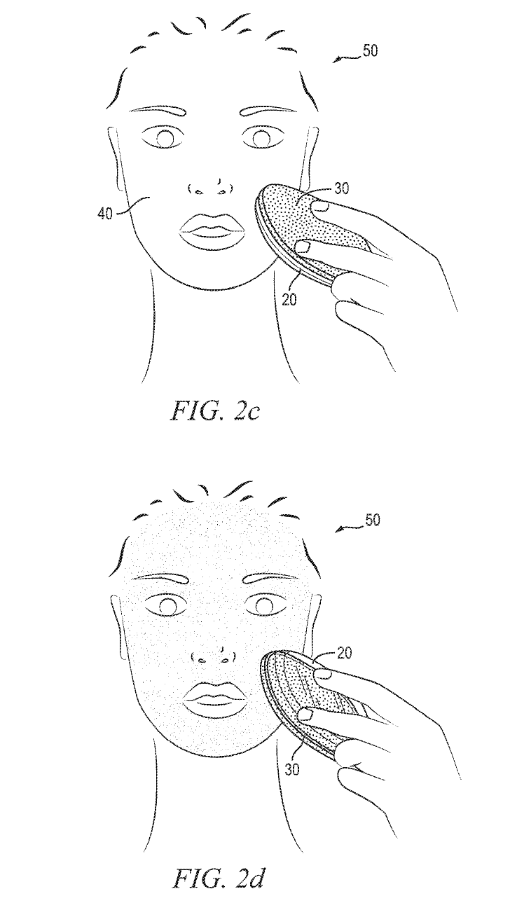

FIGS. 2a-2d illustrate usage of applicator 10. In FIG. 2a, makeup 40 is applied to silicone side 20. Makeup 40 can be applied directly from a container 42 as illustrated, or silicone side 20 can be dipped into a pool of makeup. Other types of makeup, such as powder or gel, can be applied with silicone side 20 as well.

FIG. 2b illustrates a person using silicone side 20 to apply makeup 40 to face 50. Makeup 40 can be dabbed onto face 50 at a plurality of locations as illustrated. Silicone side 20 can be dragged to spread makeup 40 and aid in transfer of the makeup from applicator 10 to face 50. The user repeatedly applies makeup 40 to silicone side 20 and dabs the makeup onto face 50 until a sufficient amount of makeup is properly distributed over the face.

FIG. 2c illustrates the user optionally using silicone side 20 to spread out the makeup across face 50. Silicone side 20 is not absorbent, allowing makeup 40 to be spread around face 50 without soaking into applicator 10. Once makeup 40 is sufficiently spread across face 50, the user flips applicator 10 and uses sponge side 30 to blend as illustrated in FIG. 2d.

A variety of techniques can be used with sponge side 30 to blend makeup 40 onto face 50. Commonly, a user pats makeup 40 into the skin of face 50 repeatedly all over the face. Sponge side 30 absorbs a little bit of makeup 40, leaving a pleasing texture of the makeup on face 50. However, since makeup 40 was already spread out in a thin layer across face 50 using silicone side 20, sponge side 30 does not absorb a substantial amount of the makeup. Sponge 30 presses makeup 40 into the skin of face 50 with each pat, absorbing just enough makeup 40 to leave a desirable texture without wasting makeup. While one specific process for applying makeup 40 is illustrated, the process may differ depending on the specific makeup being applied, the specific materials of applicator 10, and the techniques a user is accustom to performing.

Applicator 10 is a relatively flat applicator with a generally oblong shape. Both silicone side 20 and sponge side 30 include similar flat oblong shapes. The different applicator portions can be the same or different shapes in other embodiments. One or both portions may have three dimensional aspects to their respective surfaces rather than simply being flat. Any of the edges of either side can have corners or be rounded.

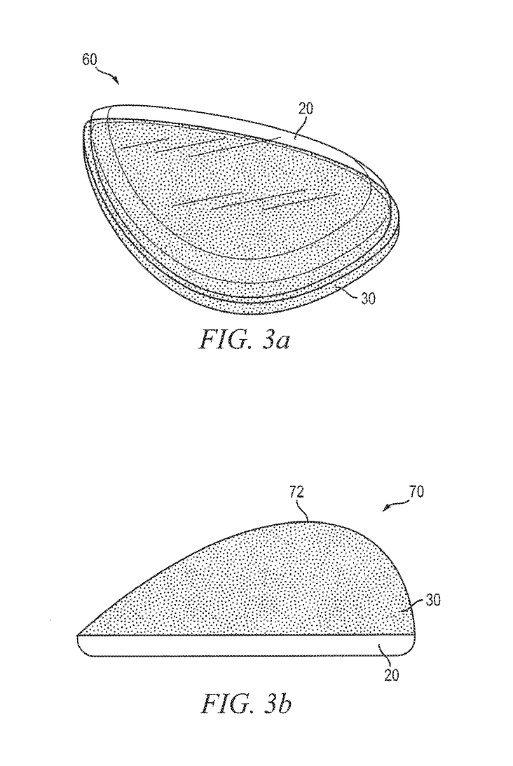

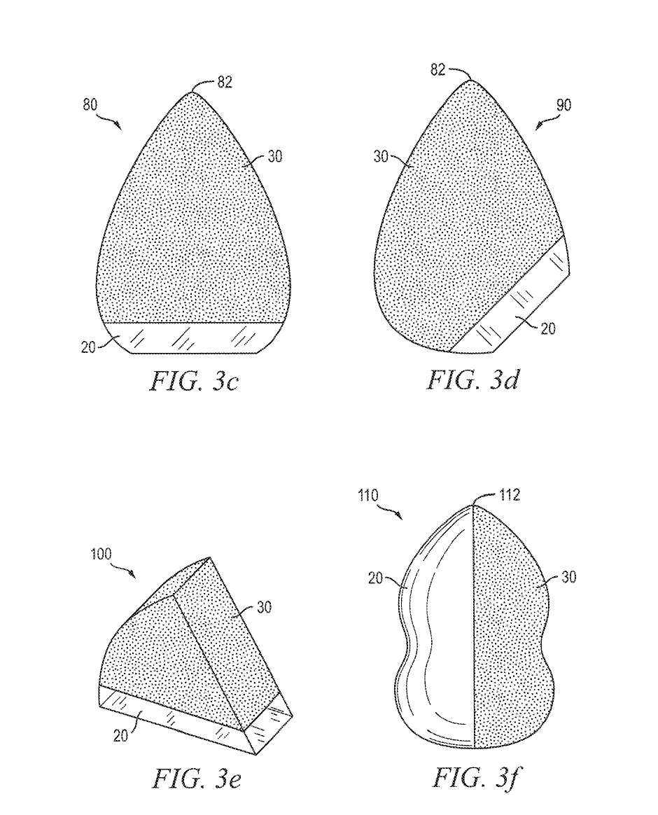

FIGS. 3a-3f illustrate a few different options for shapes usable with a double-sided makeup applicator, while any suitable shape can be used in other embodiments. FIG. 3a illustrates a teardrop or egg shaped applicator 60. Applicator 60 includes a point 62 that comes in handy for applying makeup to smaller areas, e.g., near the nose and eyes.

FIG. 3b illustrates a teardrop shaped applicator 70. Sponge side 30 of applicator 70 includes a three dimensional bump 72 extending opposite silicone side 20 rather than a flat surface. Bump 72 gives sponge side 30 more volume to absorb more liquid, and helps applicator 70 be easier to grip in a user's hand. Applicator 70 includes a flat silicone side 20, but in other embodiments the silicone side is given a three dimensional shape in addition or instead of sponge side 30.

FIG. 3c illustrates a three dimensional (3-D) teardrop shaped applicator 80. Sponge side 30 of applicator 80 includes a conical shape that extends to a point 82. Silicone side 20 is disposed opposite point 82 and has a relatively uniform thickness. In another embodiment, silicone side 20 of applicator 80 is rounded to complete the teardrop shape of sponge side 30.

FIG. 3d illustrates another teardrop shaped applicator 90. Applicator 90 includes a similar shape to applicator 80, but with silicone side 20 cocked at an angle rather than perpendicular to point 82. In some embodiments, applicators 80 and 90 can be manufactured from the same teardrop shaped sponge, and the difference is the angle at which the teardrop shape is cut prior to attachment of silicone side 20.

FIG. 3e illustrates a wedge shaped applicator 100. FIG. 3f illustrates a tapered applicator 110. Applicator 110 includes a point 112 and a circular indentation 114. Applicator 110 has a three dimensional aspect to both silicone side 20 and sponge side 30. The split between silicone side 20 and sponge side 30 for applicator 110 is right down the middle, such that fifty percent of the applicator is sponge and fifty percent is silicone.

Any of the above applicator shapes could be formed with different configurations of their respective silicone sides 20 and sponge sides 30 while maintaining the same overall applicator shape. The silicone side 20 of any of the shapes could be made larger while the sponge side 30 is made smaller, or vice versa. The cross-section angle or location between the materials could be modified for any of the above shapes. Other makeup applicator shapes are used in other embodiments.

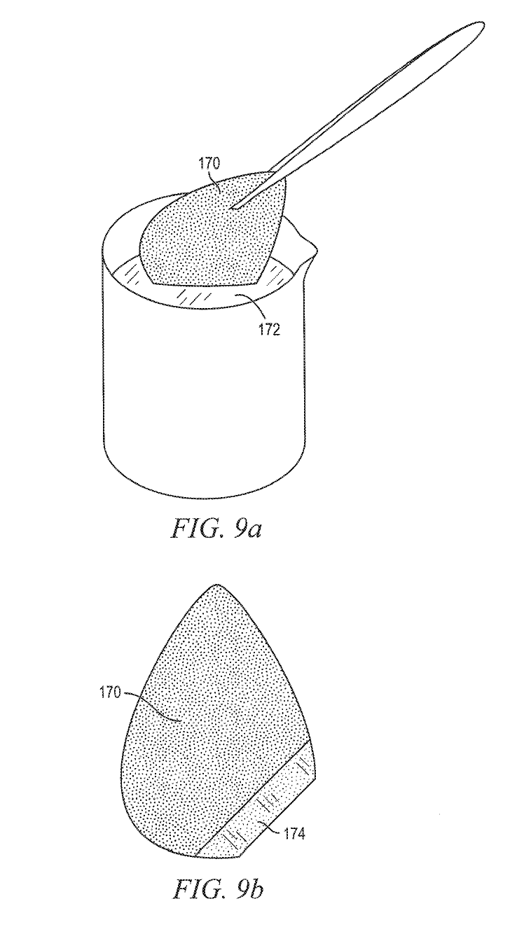

Any of the applicators could be split 50/50 between the two materials as with applicator 110, or the split could be any other suitable percentage. In some embodiments, silicone side 20 is a thin sliver of silicone, or just a coating on one or more surfaces of the applicator as illustrated in FIGS. 9a and 9b. Sponge side 30 could also be a thin foam layer or flocked coating on a silicone applicator.

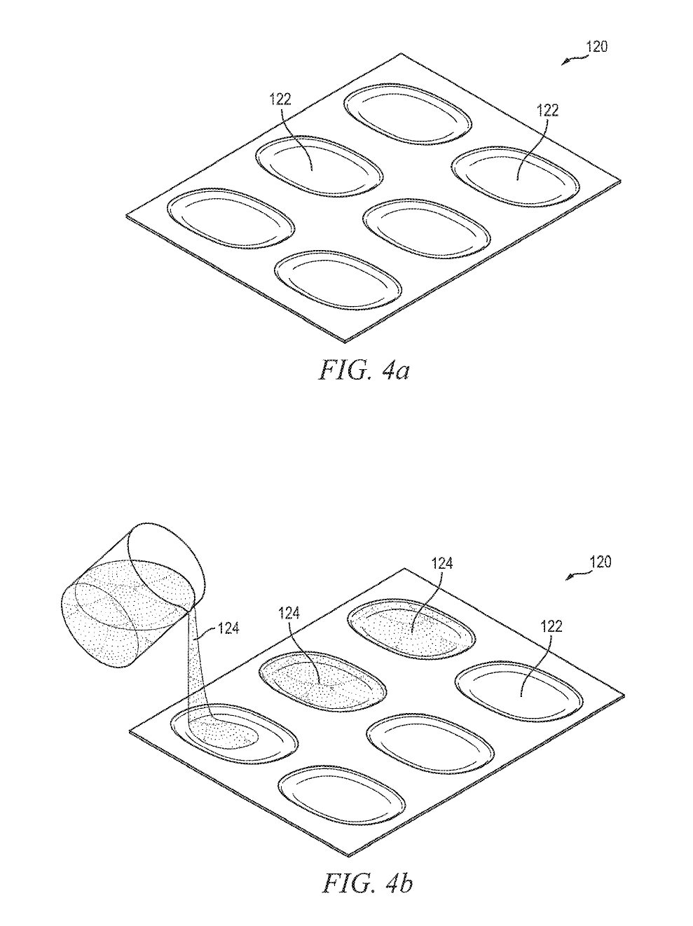

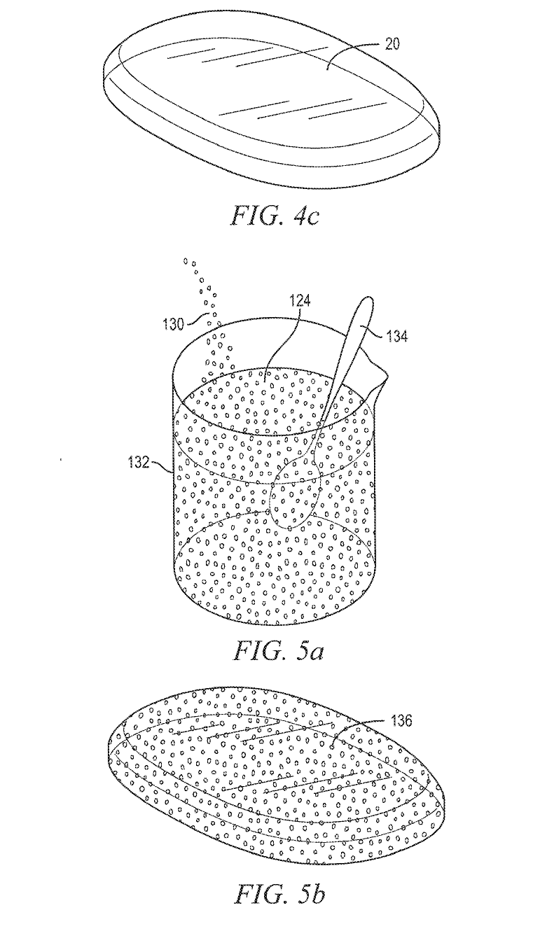

FIGS. 4a-4c illustrate one method for forming silicone side 20. FIG. 4a shows a mold 120 with a plurality of cavities 122. Each cavity 122 has a desired shape for silicone side 20. In FIG. 4b, silicone or another suitable raw material 124 is poured or otherwise deposited into mold 120 to fill each of the cavities 122. A blade is used to flatten the top surfaces of the raw material 124 coplanar with the top surface of mold 120 in some embodiments. Mold 120 holds raw material 124 in the desired shape for silicone side 20 while the material hardens or cures. In some embodiments, raw material 124 for silicone side 20 hardens simply by cooling off or by exposure to air. In other embodiments, raw material 124 cures by exposure to heat or ultraviolet radiation. FIG. 4c illustrates silicone side 20 removed from mold 120 once fully hardened or cured.

While a mold 120 suitable for pouring material into the mold is illustrated, other types of molds are used in other embodiments, e.g., transfer molding, injection molding, or investment molding. Silicone side 20 can also be cut or stamped from a sheet of material. Other suitable manufacturing methods besides molding are used in other embodiments, e.g., 3-D printing, extrusion, or machining. The manufacturing methods can be computer controlled as appropriate to ensure uniformity in the end product.

FIGS. 5a and 5b illustrate embedding silicone side 20 with glitter 130 or another suitable particulate. Raw material 124 is stored in a beaker, cup, vat, or other container 132 and glitter 130 is added while the raw material remains liquid. A spoon 134 or other device is used to evenly distribute glitter 130 within raw material 124. Raw material is translucent or transparent in many embodiments. When raw material 124 with glitter 130 is used to make silicone side 20, glitter 130 remains visible to provide an interesting and pleasing appearance to the makeup applicator. FIG. 5b illustrates a completed silicone side 136 with glitter 130 embedded.

Other suitable objects or materials can be mixed with raw material 124 to modify toe appearance, texture, density, or hardness of silicone side 20. Dye can be mixed in to configure the color or reduce the transparency of silicone side 20. Substances can be mixed in for non-aesthetic purposes, e.g., an antibacterial additive. 3-D objects can be embedded in silicone side 20 during the molding process rather than by mixing with raw material 124. A paper with instructions or a logo could be printed on and embedded within silicone side 20 during molding.

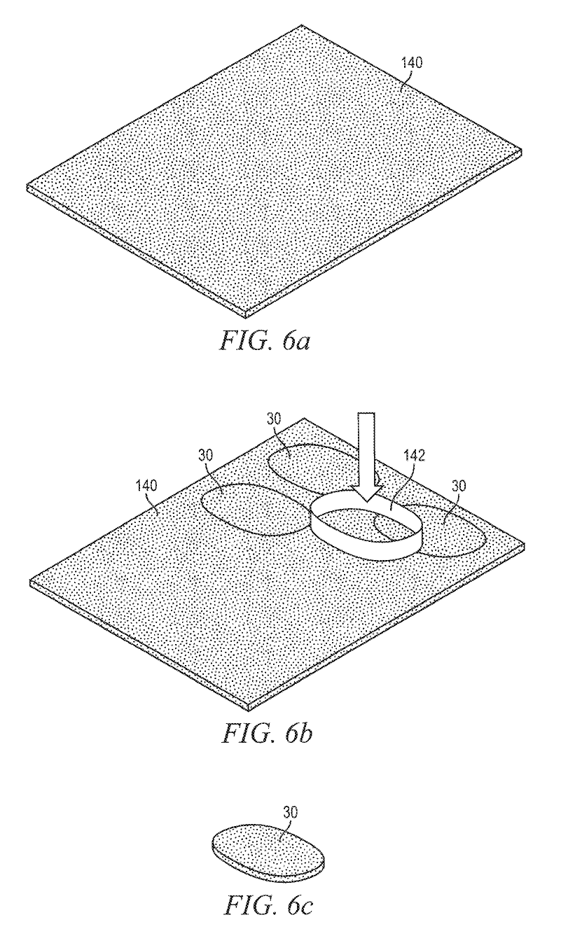

FIGS. 6a-6c illustrate one method of forming sponge side 30. Manufacturing begins by forming or purchasing a sponge sheet 140. Sponge sheet 140 can be made using any suitable process of forming a polymer foam, e.g., pouring a liquid foam into a frame and allowing the foam to dry or cure. Sponge sheet 140 can be formed from foamed polypropylene, polystyrene, polyurethane, polyvinyl chloride, silicone, polyethylene, or other suitable material. Additives may be used to change the viscosity, density, or other properties of sponge sheet 140.

In FIG. 6b, sheet 140 is cut into a plurality of sponge sides 30 using a die cutting tool 142. FIG. 6b illustrates one sponge side 30 being cut at a time, but a die could also be made to cut the entire sheet 140 of sponge sides 30 in one motion. Other cutting methods are used in other embodiments, such as manually cutting with scissors or a razor blade, laser cutting, or water jet cutting. FIG. 6c shows one of the sponge sides 30 separated from sheet 140.

While FIG. 6b illustrates cutting sponge side 30 from a sheet of material, other manufacturing methods are used in other embodiments. For three dimensionally shaped sponge sides 30, the foam material can be expanded into a mold, or cut from a larger block. Depending on the material and shape, any suitable manufacturing method can be used, including those discussed above for silicone side 20. Both silicone side 20 and sponge side 30 can be formed from the same manufacturing process, but with a different material or different additive that modifies a quality of one or both sides.

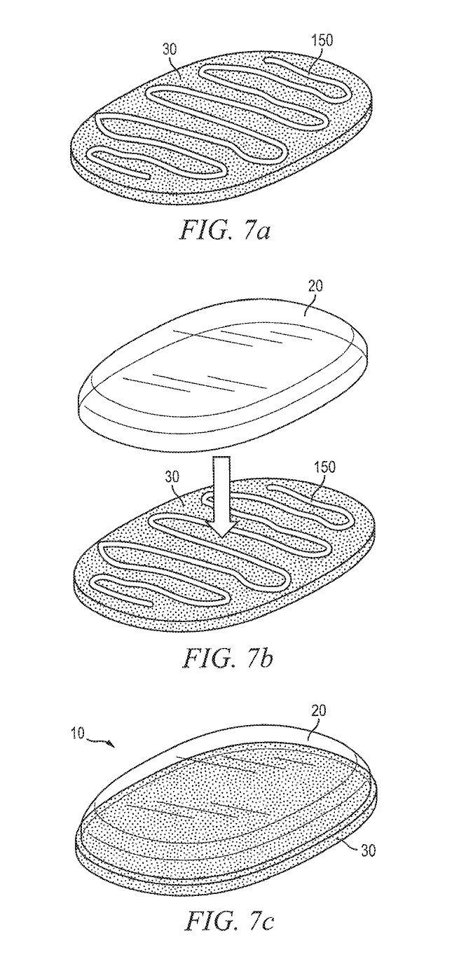

FIGS. 7a-7c illustrate combining silicone side 20 and sponge side 30 to form applicator 10. In FIG. 7a, an adhesive 150 is applied to sponge side 30. Adhesive 150 is applied as a bead patterned to cover a substantial portion of the surface of sponge side 30. In other embodiments, adhesive 150 can be brushed, sprayed, or otherwise deposited to totally cover the surface of sponge side 30. Adhesive 150 can be applied to silicone side 20 instead of, or in addition to, being applied on sponge side 30.

Any suitable adhesive can be used for adhesive 150. A waterproof adhesive, e.g., silicone based glue, can be used to improve the applicator's ability to be washed without wearing out. A silicone-based sealant also helps the applicator remain flexible. Epoxy can be used, which has a relatively high viscosity, to reduce the amount of adhesive that soaks into sponge side 30.

FIG. 7b illustrates sponge side 30 and silicone side 20 being pressed together with adhesive 150 between the two sides. In some embodiments, excess adhesive 150 is squeezed out from between the sponge side 30 and silicone side 20, and a rounded blade or other tool can be used to shape the adhesive into a fillet. A clamp, weight, or other device may be used to hold silicone side 20 and sponge side 30 together while adhesive 150 cures. In other embodiments, the weight of one side on the other is sufficient. Once adhesive 150 is cured, applicator 10 is complete and ready to use as illustrated in FIG. 7c.

In other embodiments, sponge side 30 and silicone side 20 are attached by other suitable means, e.g., by me ting the materials together. Sponge side 30 and silicone side 20 can also be formed together in the same mold. In one embodiment, foam material for both sides is expanded into a single mold to form a desired shape with different compositions between two different sides. In another embodiment, either sponge side 30 and silicone side 20 is formed and then inserted into a mold. The second side is molded around the first side. In some embodiments, the applicator is shaped after attaching sponge side 30 to silicone side 20, which helps provide a smooth transition between the two sides rather than having a lip as illustrated with applicator 10.

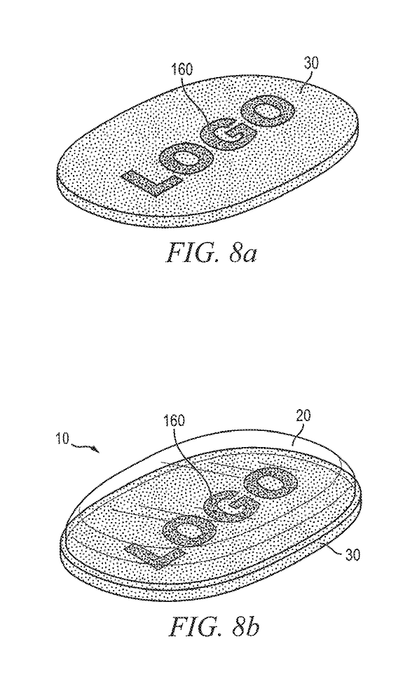

FIGS. 8a and 8b illustrate printing on applicator 10. FIG. 8a illustrates sponge side 30 with logo 160 printed on a surface. Logo 160 is placed on sponge side 30 by inkjet printing, silk screen transfer, stamping, or another suitable means. Logo 160 can alternatively be printed on silicone side 20, or printed on a flat substrate inserted between silicone side 20 and sponge side 30. Any suitable printed matter could be added rather than just a brand logo, e.g., instructions, warnings, information, or an advertisement.

FIG. 8b illustrates silicone side 20 attached to sponge side 30 as shown in FIGS. 7a-7c. Silicone side 20 is transparent or translucent, resulting in logo 160 being visible through the silicone side. A manufacturer could also print on the outside of applicator 10 before or after combining the two sides. Printing between silicone side 20 and sponge side 30 allows a manufacturer to add printed material to the product that is not exposed to the wear and tear of normal usage as printing on the outside of the unit would

FIGS. 9a and 9b illustrate making an applicator by dipping one material into a liquid to form a coat of a second material. FIG. 9a shows dipping a makeup sponge 170 into a liquid silicone 172. Makeup sponge 170 can be any suitable sponge for applying makeup. Dipping sponge 170 into liquid silicone 172 results in a thin layer or coating 124 of silicone applied over a portion of the sponge as illustrated in FIG. 9b. Sponge 170 with silicone coating 174 has many of the same benefits of applicator 10, i.e., a single tool with both a porous section to blend makeup and a non-porous section useful for applying and spreading makeup. The dipping process provides similar benefits while reducing the manufacturing complexity of separately forming silicone sides 20. Rather than dipping, silicone 172 could be brushed, rolled, sprayed, or otherwise coated onto one or more surfaces of sponge 170. If desired, tape can be used as a masking layer to give a straight edge to the silicone coating 174.

In other embodiments, a silicone applicator is dipped in a liquid that dries into a foamy surface, resulting in a single tool that still provides the same two types of surfaces. Any suitable makeup applicator can be dipped into any suitable material to add a coating for accomplishing a second purpose. In one embodiment the coating 174 is used as an adhesive in a flocking process. Sponge 170 is dipped into the adhesive and then into a container of flocking fibers. The flocking fibers stick to sponge 170 to give a different characteristic to the dipped surface. Flocking one way to apply a texture to one side of a silicone applicator without substantially increasing the amount of makeup absorbed during blending.

While one or more embodiments of the present invention have been illustrated in detail, the skilled artisan will appreciate that modifications and adaptations to those embodiments may be made without departing from the scope of the present invention as set forth in the following claims.

What is claimed:

1. A makeup applicator, comprising:
a non-foam polymer pad; and
a sponge attached to the non-foam polymer pad.

2. The makeup applicator of claim 1, further including a dye disposed in the non-foam polymer pad.

3. The makeup applicator of claim 1, further including a particulate disposed in the non-foam polymer pad.

4. The makeup applicator of claim 1, further including an adhesive disposed between the non-foam polymer pad and sponge.

5. The makeup applicator of claim 1, further including a text or picture printed on a surface of the sponge, wherein the non-foam polymer pad is attached to the surface of the sponge.

6. The makeup applicator of claim 1, wherein the sponge includes an open-cell polymeric foam.

7. A makeup applicator, comprising:
a porous surface; and
a non-porous surface opposite the porous surface.

8. The makeup applicator of claim 7, further including a sponge comprising the porous surface.

9. The makeup applicator of claim 8, wherein the non-porous surface is a coating over a surface of the sponge.

10. The makeup applicator of claim 9, further including flocking fibers attached to the coating.

11. The makeup applicator of claim 7, further including a silicone pad comprising the non-porous surface.

12. The makeup applicator of claim 11, further including a sponge comprising the porous surface, wherein the sponge is attached to the silicone pad.

13. The makeup applicator of claim 7, further including a text or image printed under the non-porous surface and visible through the non-porous surface.

14. A method of making a makeup applicator, comprising:
providing a first material; and
attaching a second material to the first material, wherein the first material is different from the second material.

15. The method of claim 14, further including attaching the second material to the first material by dipping the first material into the second material to form a coat.

16. The method of claim 14, further including attaching the second material to the first material using an adhesive.

17. The method of claim 14, further including mixing a particulate into the first material.

18. The method of claim 14, further including mixing a dye into the first material.

19. The method of claim 14, further including cutting the first material from a sheet.

20. The method of claim 14, further including forming the first material in a mold.
